(19) United States
(12) Patent Application Publication
(10) Pub. No.: US 2007/0015392 A1
(43) Pub. Date: Jan. 18, 2007

(54) Process for sealing internal components of a vehicle door

(76) Inventor: Gerardo Villagomez Cardenas, Dallas, TX (US)

Correspondence Address: RUBEN C. DELEON;WINSTEAD SECHROST & MINICK P.C., P.O. BOX 50784, DALLAS, TX, 75201, US

(21) Appl. No.: 11/180,770

(22) Filed: Jul. 13, 2005

(51) Int. Cl. H01R 13/64

(52) U.S. Cl. 439/247

(57) ABSTRACT

The present invention is a system and process for effectively sealing the internal components of a vehicle door. The system includes a vehicle door base installed with the internal components and a front connector and a back connector, a sealant applied on the front and back connector to permanently sealed the external panel onto the vehicle door base, and a temporary adhesive component applied onto the front and back connector to reinforce the sealing of the external panel onto the vehicle door base while the sealant for the permanent seal is curing.

### REFERENCE TO PENDING APPLICATIONS

Not Applicable.

### REFERENCE TO MICROFICHE APPENDIX

Not Applicable.

### BACKGROUND OF THE INVENTION

The present invention relates to adhesive component applications and more particularly to a system and process for applying and utilizing a temporary adhesive component to instantly reinforce the sealing of an external panel to a vehicle door base while a permanent sealant is curing.

Historically, vehicle door assembly is carried out by electrically spot-welding of an external panel onto a vehicle door base. This process is difficult and time consuming. Moreover, because the external panel is embedded on the door base by electrical spot-welding, it is inconvenient to carry out internal or external repair of the door. In some cases the disassembly of the door or a replacement of an entire door is required.

In an attempt to improve the door assembly process, increase the productivity and alleviate problems during door repair, assemblers of vehicle doors began using point-welding, by sealing the external panel onto the vehicle door base utilizing a urethane sealant.

This particular door assembly process created new problems. For example, the external panel would shift and not be in proper ideal position while seated and fitted onto the door base because the urethane sealant utilized required at least 72 hours to cure and solidify.

When the external panel is sealed onto the door base using the urethane sealant, the assembled door is then transported along an assembly line to the next assembling station. During the transportation, the sealant is in the active process of curing and solidifying. Such transportation inevitably causes the external panel to shift and become misaligned on the door base. As a result most door assemblies required refitting and realigning due to this problem.

Further scope of the applicability of the present invention will become apparent from the detailed description to follow, taken in conjunction with the accompanying drawings wherein like parts are designated by like reference numerals.

### SUMMARY OF THE INVENTION

The present invention is directed towards an improved sealing system and method that is specifically adapted to be used to instantly seal an external panel onto a door base, such as an automobile door base, while a primary sealant is curing. By using the temporary adhesive components described in the present invention, the external panel will be instantly sealed and maintained in proper position during transportation along an assembly line.

In accordance with the present invention, the internal components are installed on a vehicle door base, and the vehicle door base has a front edge for securing a front connector and a back edge for securing a back connector. Each of the front connector and the back connector has extended surface areas for applying a temporarily adhesive component and a sealant. Preferably, each connector has three surface areas, one for applying the adhesive applying the adhesive component and the other two for applying the sealant. These surface areas are preferably rectangular lines along the connectors from end to end, and they are substantially parallel to each other. The sealant utilized may be any common type of permanent sealing reagents in metal panel sealing, but preferably, the sealant is a urethane sealant.

In the present invention, in order to instantly seal an external panel to the vehicle door base, a temporarily adhesive component is used to achieve this purpose. Specifically, by applying the temporarily adhesive component in conjunction with applying the sealant to seal the external panel onto the door base, the temporarily adhesive component makes the external panel instantly bind to the door base while the sealant is still curing. As a result, the external panel will stay in the desired position in subsequent assembly steps and will not shift or slipped when the sealant is curing and solidifying.

According to the present invention, the temporary adhesive component used for instantly seal the external panel to the vehicle door base is a double-face adhesive tape. One side of the tape is applied on a surface area of the front connector or the back connector and the other side of the tape is adhered onto inner surface of the external panel when the external panel is sealed onto the door base with the sealant.

The double-face adhesive tape has a protective liner on each side. The protective liner on one side is removed when this side is applied. Preferably, the removing of the protective liner and applying the adhesive tape are performed by application robots.

More preferably, the double-face adhesive tape is a foam tape of a specified thickness that permits seamless jointing between the external panel and the front and back connectors onto the door base. When they are sealed, the desired thickness of the foam tape can be achieved when the external panel is pressed onto the vehicle door base to make the seal. In further accordance with the present invention, the length and the width of the tape are applied according to the length and the width of the surface area of the front connector or the back connector.

According to the present invention, the sealant may be applied onto designated surface areas of the front connector and the back connector. The sealant is more preferably applied onto designated inner surface areas of the external panel whereby when the external panel is aligned and press onto the door base, the sealant will made direct contact with designated surface areas of the front connector and the back connector to make a seal.

It should be understood that any one of the features of the invention may be used separately or in combination with other features. It should be understood that features which have not been mentioned herein may be used in combination with one or more of the features mentioned herein. Other systems, methods, features, and advantages of the present invention will be or become apparent to one with skill in the art upon examination of the drawings and detailed description. It is intended that all such additional systems, methods, features, and advantages be included within this description, be within the scope of the present invention, and be protected by the accompanying claims.

These and other objects, features and advantages of the present invention will be more readily apparent when considered in connection with the following, detailed description of preferred embodiments of the invention, which description is presented in conjunction with annexed drawings below.

### BRIEF DESCRIPTION OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. For a more complete understanding of the present invention, and the advantages thereof, reference is now made to the following descriptions taken in conjunction with the accompanying drawings, in which:

FIG. 1 is a perspective view of the vehicle door with front and back connectors attached thereto according to an embodiment of the present invention; and

FIG. 2 is a perspective view of a front and/or back connector as depicted in FIG. 1 according to an embodiment of the present invention.

### DETAILED DESCRIPTION OF THE PREFERRED EMBODIMENT

The following discussion is presented to enable a person skilled in the art to make and use the invention. The general principles described herein may be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative of but a few of the various ways in which the principles of the invention may be employed. Other objects, advantages and novel features of the invention will become apparent from the following detailed description of the invention when considered in conjunction with the drawings.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It will be understood by one skilled in the art that the present invention disclosed hereinbelow may be used in virtually any vehicle door construction and sealing operation and can be utilized in conjunction with automobile door assembly lines.

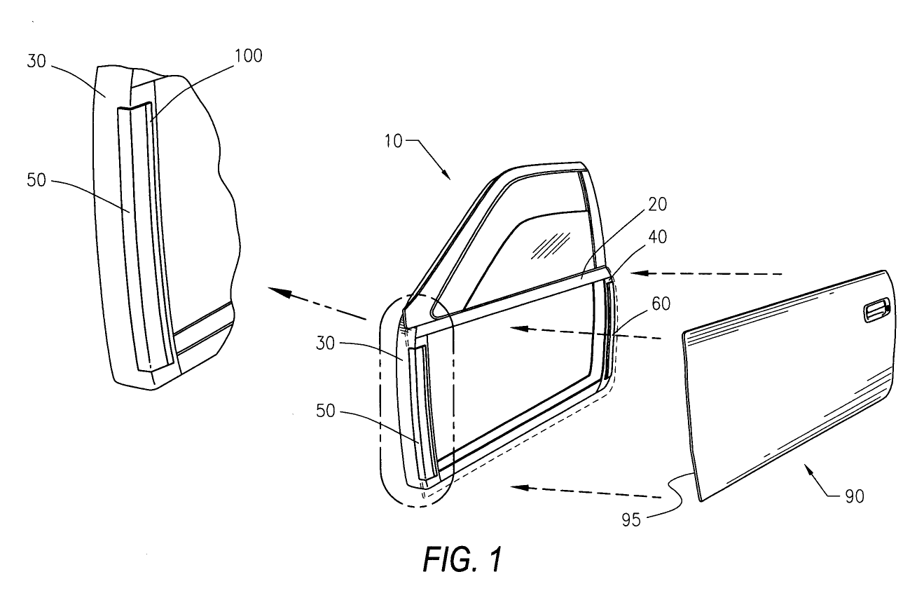

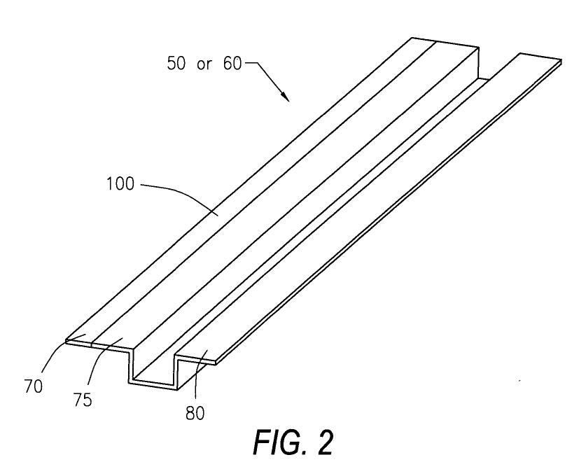

Turning now to FIGS. 1 and 2, in accordance with the present invention, what is shown is a vehicle door 10 have a vehicle door base 20 wherein internal and external components (both not shown) are installed. The vehicle door base 20 has a front edge 30 for securing a front connector 50 and a back edge 40 for securing a back connector 60. Each of the front connector 50 and the back connector 60 has a plurality of extended surface areas 70, 75, 80 (shown in FIG. 2) for applying a temporary adhesive component and a sealant (both not depicted in the Figures). Preferably, each of the front connector 50 and the back connector 60 has three surface areas 70, 75 and 80, one for applying the adhesive applying the adhesive component 70 and the other two 75, 80 for applying the sealant such as, but not limited to any common type of permanent sealing reagent utilized for metal panel sealing. For example, the sealant may be a urethane sealant. The surface areas 70, 75 and 80 are preferably substantially parallel rectangular surfaces, as can be seen in FIG. 2, that traverse along the longitudinal axis of the front connector 50 and the back connector 60 from end to end.

In the present invention, in order to instantly seal an external panel 90 to the vehicle door base 20, a temporary adhesive component is utilized. Specifically, by applying the temporary adhesive component in conjunction with applying the sealant to seal the external panel 90 onto the vehicle door base 20, the temporary adhesive component makes the external panel 90 instantly bind to the vehicle door base 20 while the sealant's curing process takes place. As a result, the external panel 90 remains in a predetermined desired position in subsequent assembly steps along an assembly line and as a result will not shift or slip from the predetermined desired position while the sealant is curing and solidifying.

In the present invention, the temporary adhesive component such as, but not limited to, a double-face adhesive tape 100 is preferably used for instantly sealing the external panel 90 to the vehicle door base 20. One side of the double-face adhesive tape 100 is applied to surface area 70 of the front connector 50 or to surface area 70 of the back connector 60 and the other side of the double-face adhesive tape 100 is adhered onto an inner surface 95 of the external panel 90 when the external panel 90 is sealed onto the door base 20 utilizing the sealant. The double-face adhesive tape 100 has a protective liner (not shown) on each side thereof. The protective liner on one side is removed when that side of the double-face adhesive tape 100 is applied. Preferably, the removing of the protective liner and applying the double-face adhesive tape 100 are performed by application robots but can be accomplished manually if required.

The double-face adhesive tape 100 is preferably a foam tape but is not limited only thereto. The double-face adhesive tape 100 is utilized in a predetermined thickness to allow substantially seamless adherence of the external panel 90 and the front and back connectors 50, 60 onto the door base 20. When the connectors 50, 60 are sealed, the desired thickness of the foam tape can be achieved when the external panel 90 is pressed onto the vehicle door base 20 to make the seal. Furthermore, the length and the width of the double-face adhesive tape 100 are applied according to the length and the width of the surface area of the front connector 50 and/or the back connector 60.

In the present invention, the sealant can be applied onto the designated extended surface areas 75, 80 of the front connector 50 and the back connector 60. The sealant is more preferably applied onto designated inner surface areas 95 of the external panel 90 whereby when the external panel 90 is aligned and pressed onto the door base 20, the sealant will make a direct contact with the designated extended surface areas 75, 80 of the front connector 50 and the back connector 60 to make a seal.

The present invention discloses a process for sealing the internal components of a vehicle door 10 comprising the steps of providing a vehicle door base 20, having installed thereon the internal components, a front connector 50 and a back connecter 60; providing a reinforcing edge of the front connector 50 and a reinforcing edge of the back connector 60; applying a first side of a double-face adhesive tape 100 onto a first surface area 70 of the reinforcing edge of the front connector 50; applying a first side of a double-face adhesive tape 100 onto a first surface area of the reinforcing edge of the back connector 60; applying a sealant, such as, but not limited to a urethane sealant, onto a second 75 and a third surface area 80 of the reinforcing edge of the front connector 50; applying the sealant onto a second 75 and a third surface areas 80 of the reinforcing edge of the back connector 60; providing an external panel 90; sealing the external panel 90 onto the vehicle door base 20 (for example by application robots) by engaging the sealant onto inner surface areas 95 of the external panel 90 and a second side of the first adhesive tape 100 and a second side of the second adhesive tape 100 onto inner surface 95 of the external panel 90; whereby the external panel 90 is instantly sealed onto said door base 20 by the first and second adhesive tapes while the sealant is cured.

The process also discloses herein that a sealant can be applied onto designated surface areas on the inner surface 95 of the external panel 90 in the assembly line by application robots, whereby when the external panel 90 is sealed onto the door base 20, the sealant is engaged on the second 75 and third surface areas 80 of the reinforcing areas of the front connector 50 and of the reinforcing edge of the back connector 60.

In addition, the process also may comprise the steps of pealing off a first protective liner of the first tape 100 and a first protective liner of the second tape 100, wherein the pealing step can be performed by a person or by an application robot; applying a first side of the first tape 100 on the first surface area of the reinforcing edge of the front connector 50; applying a first side of the second tape on the first surface area of the reinforcing edge of the back connector 60; applying the sealant on inner surface of the external panel 90; sealing the external panel 90 onto the vehicle door base 20 by engaging the sealant onto inner surface areas 95 of the external panel 90 and a second side of the first adhesive tape and a second side of the second adhesive tape onto inner surface 95 of the external panel 90; whereby the external panel 90 is instantly sealed onto the door base 20 by said first and second adhesive tapes while the sealant is cured.

In accordance with the process disclosed above the vehicle door base 20 is installed with the internal components but excluding the external panel 90. In addition, the front connector 50 and the back connector 60 have reinforcing edges that are used for applying the adhesive tapes 100 and the sealant. The adhesive tapes 100 have a differing width, length and thickness to allow the external panel 90 to be properly sealed onto the door base 20. The process may utilize double-face adhesive tapes 100 made of foam.

The present invention also discloses a system for sealing the internal components of a vehicle door 10 comprising a vehicle door base 20 having a front connector 50 and a back connector 60 having reinforcing edges for applying adhesive tape 100, of a specified thickness for permitting seamless sealing of the external panel 90 onto the vehicle door base 20 and differing widths to fit the surface area of the reinforcing edges of the front 50 and back connectors 60 and differing lengths to fit the surface area of the surface area of the reinforcing edges of the front 50 and back connectors 60, and a sealant such as, but not limited to, a urethane sealant, wherein the vehicle door base 20 is installed with the internal components except for an external panel 90, wherein the adhesive tapes may be of a foam tape having protective liners on both sides; an external panel 90, wherein a sealant is utilized for sealing the external panel 90 onto the vehicle door base 20; a first double-face adhesive tape 100 applied to the front connector 50; and a second double-face adhesive tape 100 applied to the back connector 60 for cooperatively reinforcing the sealing of the external panel 90 onto the door base 20.

In addition, the present invention also discloses a process for instantly reinforcing the sealing of internal components of a vehicle door 10, the process comprising the steps of providing a vehicle door base 20, wherein the vehicle door base 20 is installed with the internal components, except the external panel 90, having a front connector 50 and a back connector 60 installed, wherein the front connector 50 and the back connector 60 have reinforcing edges 70, 75, 80 for applying a temporary adhesive component such as, but not limited to, double-face adhesive foam tape, and the permanent sealants such as, but not limited to urethane sealants; applying a first temporarily adhesive component on a first surface area 70 of the front connector 50 and applying a second temporarily adhesive component on a first surface area 70 of the back connector 60; applying a first permanent sealant onto a second surface area 75 of the front connector 50 and a second permanent sealant onto a second surface area 75 of the back connector 60; providing an external panel 90; and sealing the external panel 90 onto the door base 20 by engaging the first and second temporarily adhesive components and the first and second permanent sealants; whereby the external panel 90 and the door base 20 are instantly sealed by the temporarily adhesive components while the sealants cure.

In addition to the process steps above the sealants can also be applied onto designated surface areas on the inner surface 95 of the external panel 90, whereby when the external panel 90 is sealed onto the door base 20, the sealants are engaged on the second 75 and third surface 80 areas of the reinforcing areas of the front connector 50 and of the reinforcing edge of the back connector 60.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired.

It is therefore, contemplated that the claims will cover any such modifications or embodiments that fall within the true scope of the invention.

1. A process for sealing the internal components of a vehicle door, comprising the steps of:
providing a vehicle door base, having installed the internal components and a front connector and a back connecter;
providing a reinforcing edge of the front connector and a reinforcing edge of the back connector;
applying a first side of a double-face adhesive tape onto a first surface area of the reinforcing edge of the front connector;
applying a first side of a double-face adhesive tape onto a first surface area of the reinforcing edge of the back connector;
applying a sealant onto a second and a third surface area of the reinforcing edge of the front connector;
applying the sealant onto a second and a third surface areas of the reinforcing edge of the back connector;
providing an external panel; and
sealing the external panel onto the vehicle door base by engaging the sealant onto inner surface areas of the external panel and a second side of the first adhesive tape and a second side of the second adhesive tape onto inner surface of the external panel;
whereby the external panel is instantly sealed onto said door base by the first and second adhesive tapes while the sealant is cured.

2. The process in accordance with claim 1, wherein the vehicle door base is installed with the internal components, excluding the external panel.

3. The process in accordance with claim 1, wherein the front connector and the back connector have reinforcing edges for applying the adhesive tapes and the sealant.

4. The process in accordance with claim 1, wherein the double-face adhesive tapes are foam tapes.

5. The process in accordance with claim 1, wherein the adhesive tapes have different width, length, and thickness whereby the external panel can be properly sealed onto said door base.

6. The process in accordance with claim 1, wherein the sealant is a urethane sealant.

7. The process in accordance with claim 1, wherein the sealant can be applied onto designated surface areas on the inner surface of the external panel, whereby when the external panel is sealed onto the door base, the sealant is engaged on the second and third surface areas of the reinforcing areas of the front connector and of the reinforcing edge of the back connector.

8. The process in accordance with claim 1, further comprising steps of:
pealing off a first protective liner of the first tape and a first protective liner of the second tape;
applying a first side of the first tape on the first surface area of the reinforcing edge of the front connector;
applying a first side of the second tape on the first surface area of the reinforcing edge of the back connector;
applying the sealant on inner surface of the external panel; and
sealing the external panel onto the vehicle door base by engaging the sealant onto inner surface areas of the external panel and a second side of the first adhesive tape and a second side of the second adhesive tape onto inner surface of the external panel;
whereby the external panel is instantly sealed onto the door base by said first and second adhesive tapes while the sealant is cured.

9. The process in accordance with claim 1, wherein the steps of peeling off the protective liners of the first tape and second tape can be performed by a person or by an application robot;

10. The process in accordance with claim 1, wherein the steps of applying sealant are performed in the assembly line by application robots.

11. The process in accordance with claim 1, wherein the steps of placing and engaging the external panel for sealing it onto door bases are performed by application robots.

12. A system for sealing the internal components of a vehicle door comprising:
a vehicle door base having a front connector and a back connector;
an external panel, wherein a sealant is utilized for sealing the external panel onto the vehicle door base;
a first double-face adhesive tape applied to the front connector; and
a second double-face adhesive tape applied to the back connector for cooperatively reinforcing the sealing of the external panel onto the door base.

13. The system of claim 12, wherein the vehicle door base is installed with the internal components, excluding the external panel.

14. The system of claim 12, wherein the front connector and the back connector have reinforcing edges for applying the adhesive tapes and the sealant.

15. The system of claim 12, wherein the adhesive tapes are foam tapes having protective liners on both sides.

16. The system of claim 12, wherein the adhesive tapes have certain thickness whereby the external panel is sealed seamlessly onto the vehicle door base.

17. The system of claim 12, wherein the adhesive tapes have different widths to fit the surface area of the reinforcing edges of the front and back connectors.

18. The system of claim 12, wherein the adhesive tapes have different lengths to fit the surface area of the reinforcing edges of the front and back connectors.

19. The system of claim 12, wherein the sealant is a urethane sealant.

20. A process for instantly reinforcing the sealing of internal components of a vehicle door, the process comprising the steps of:
providing a vehicle door base, having a front connector and a back connector installed;
applying a first temporarily adhesive component on a first surface area of the front connector and applying a second temporarily adhesive component on a first surface area of the back connector;
applying a first permanent sealant onto a second surface area of the front connector and a second permanent sealant onto a second surface area of the back connector;
providing an external panel; and
sealing the external panel onto the door base by engaging the first and second temporarily adhesive components and the first and second permanent sealants;
whereby the external panel and the door base are instantly sealed by the temporarily adhesive components while the sealants are cured.

21. The process in accordance with claim 20, wherein the vehicle door base is installed with the internal components, excluding the external panel.

22. The process in accordance with claim 20, wherein the front connector and the back connector have reinforcing edges for applying the temporarily adhesive component and the permanent sealants.

23. The process in accordance with claim 20, wherein the temporary adhesive component is double-face adhesive foam tape.

24. The process in accordance with claim 20, wherein the sealants are urethane sealants.

25. The process in accordance with claim 20, wherein the sealants can be applied onto designated surface areas on the inner surface of the external panel, whereby when the external panel is sealed onto the door base, the sealants are engaged on the second and third surface areas of the reinforcing areas of the front connector and of the reinforcing edge of the back connector.

26. The process in accordance with claim 6, wherein an adhesive tape is used in place of the urethane sealant.

27. The process in accordance with claim 26, wherein the adhesive tape used in place of the urethane sealant is a double-sided foam urethane tape.

28. The system in accordance with claim 19, wherein an adhesive tape is used in place of the urethane sealant.

29. The system in accordance with claim 28, wherein the adhesive tape used in place of the urethane sealant is a double-sided foam urethane tape.

30. The process in accordance with claim 24, wherein an adhesive tape is used in place of the urethane sealant.

31. The process in accordance with claim 30, wherein the adhesive tape used in place of the urethane sealant is a double-sided foam urethane tape.
